(19) United States
(12) Patent Application Publication
(10) Pub. No.: US 2010/0197510 A1
(43) Pub. Date: Aug. 5, 2010

(54) METHODS FOR RAPID DISEASE SCREENING

(76) Inventors: Michael Spain, Austin, TX (US); Craig Benson, Austin, TX (US); James P. Mapes, Austin, TX (US); Ralph L. McDade, Austin, TX (US)

Correspondence Address: FOLEY AND LARDNER LLP;SUITE 500, 3000 K STREET NW, WASHINGTON, DC, 20007, US

(21) Appl. No.: 12/529,840

(22) PCT Filed: Mar. 7, 2008
(86) PCT No.: PCT/US08/56148

§ 371 Date: Apr. 5, 2010

Related U.S. Application Data
(60) Provisional application No. 60/893,810, filed on Mar. 8, 2007.

(51) Int. Cl. C40B 30/00

(52) U.S. Cl. 506/7

(57) ABSTRACT

Methods are provided for screening for the necessity for further diagnosis of one or more diseases or conditions in a subject, which methods are based on the discovery that abnormal levels of selected analytes in a sample fluid from a subject can be correlated with specific diseases or conditions. Further provided are criteria, and methods for the determine thereof, for selected analytes with respect to selected diseases or conditions. Thus, a variety of diseases or conditions can be screened in a rapid, cost-effective composite assay. The methods are useful for screening of newborn humans for a variety of diseases and conditions, whereby additional diagnostic procedures need only be conducted for those diseases or conditions indicated by the methods of the invention.

### CROSS-REFERENCE TO RELATED APPLICATIONS

The present application claims priority to U.S. provisional application No. 60/893,810 filed Mar. 8, 2007, the disclosure of which is incorporated herein by reference in its entirety.

### BACKGROUND OF THE INVENTION

The present invention relates generally to the field of diagnostic screening. In particular, the invention provides methods of diagnosis for single diseases or conditions, and for groups of diseases or conditions, which methods are based on comparison, in view of independently selected screening criteria for each analyte, of the concentration of one or more selected analytes assayed in a fluid sample from a subject. The present invention further provides methods of screening for the necessity of further diagnosis of a disease or condition indicated as likely in the subject.

The information provided herein is intended solely to assist the understanding of the reader. None of the information provided nor references cited is admitted to be prior art to the present invention. Each of the references cited herein is incorporated in its entirety and for all purposes.

Screening for disease is a paradigm of modern medical practice. In particular, newborn screening is the practice of testing newborns for certain harmful or potentially fatal disorders that are not otherwise apparent at birth. Such screening is directed at a variety of individual diseases and conditions, including those of metabolic, genetic, and/or hormonal origin. Testing for specific diseases with individualized assays is time consuming and costly, however, and because each test requires a biological sample, a patient may be subject to painful procedures to retrieve the sample. What is more, without knowing what conditions, if any, may afflict the patient, patients are invariably subject to a battery of tests that could otherwise have been prevented. Hence, because most of the United States and territories mandate newborn screening, there is significant impetus, from both economic and medical practice viewpoints, for the development and proliferation of rapid screening methods having low overall cost. There is also a need for a screen that may render a diagnosis of “healthy” (or “unhealthy”), with a healthy diagnosis rendering the need for the aforementioned battery of tests for specific diseases unnecessary.

### SUMMARY OF THE INVENTION

The invention provides rapid methods of screening to determine whether a subject is “normal” or “healthy”. The method can be practiced with a determination of the concentrations of one or two or more biomarkers in a patient fluid sample. Elevated (or depressed, as the case might be) levels of the biomarkers, which are statistically different from levels found in “normals” (that is, control subjects not suffering from disease), support a positive diagnosis of disease. Preferably, the method utilizes a panel of analytes or “biomarkers” found in a sample fluid (e.g., blood spots, whole blood, serum, plasma, or urine), to help support a positive or negative diagnosis of disease. Up to 99% accuracy in making a correct diagnosis is provided by the method.

Upon using the inventive screen, “normal” or “healthy” subjects need not be subject to additional tests for the presence or absence of specific diseases. Indeed, according to the invention, such tests would be superfluous. However, “abnormal” or “unhealthy” subjects, may require further tests to determine the identity of the afflicting condition. In this way, the invention provides a rapid method of screening subjects to determine whether further diagnostic procedures must be employed to determine whether the subject (e.g., a human subject, or preferably, a human newborn) suffers from one or more diseases or conditions.

Hence, the present invention is a “negative predictor” of disease (i.e., predicts the absence of disease(s)) rather than conventional “positive predictor” assays that determine the presence of disease. In other words, rather than diagnose the presence or absence of specific disease conditions, the present invention may be characterized as an assay to determine whether the subject is generally healthy. Hence, a “healthy” result obviates the need for additional assays to determine the presence (or absence) of any specific disease. Alternatively, if the inventive assay returns an “unhealthy” result, further tests to determine the nature of the disease or condition become necessary.

By way of example without limitation, current newborn screening is disease oriented in that the presence or absence of indicia for specific diseases is analyzed. Assays A, B, C, . . . Z are used to test for diseases a, b, c, . . . z. The present invention provides a single assay that, if a “healthy” result is obtained, is sufficient to show that none of diseases a, b, c, . . . z are present in the subject. The subject is thus spared the time, cost, and suffering of the additional tests. To be sure, however, if the instant invention returns an “unhealthy” result, additional “positive predictor” assays for any of diseases a, b, c, . . . z become necessary.

The method can be practiced by determination of the concentrations of one or more analytes in a fluid sample from a subject, comparison of the concentrations so obtained with pre-selected screening criteria, wherein the screening criteria are adapted to provide high sensitivity, and determining, based on the comparison, whether further diagnosis is indicated. Preferably, the methods provided herein contemplate a plurality of analytes obtained in a sample fluid, each analyte having a defined screening criterion. Accordingly, the present invention provides methods to screen for the likelihood that a subject has a specific disease or condition, wherein such likelihood then indicates whether the specific disease or condition should be further diagnosed.

In a first aspect, the invention provides a method of screening for the necessity for further diagnosis of one or more diseases or conditions in a human subject, which method includes the following steps: (a) obtaining a fluid sample from a human subject in need of screening for the necessity for further diagnosis of one or more diseases or conditions; (b) determining the concentration of one or more analytes in the fluid sample; (c) comparing each concentration of the one or more analytes with independently selected screening criteria, wherein the independently selected screening criteria are adapted such that the sensitivity of a composite assay is at least 80%; and (d) determining if said further diagnosis is required, thereby providing screening for the necessity for further diagnosis of the one or more diseases or conditions in the human subject.

“Diagnosis” and like terms refer to the process of identifying a disease or condition by the signs, symptoms and/or results of various analytic procedures associated with the disease or condition, and to an identification of the disease or condition associated with the signs, symptoms and/or results of various analytic procedures. “Further diagnosis” and like terms refer to diagnosis conducted in view of a decision based on a screening method as described herein.

“Groups of diseases or conditions” and like terms refer to diseases or conditions which are associated, for example without limitation, by association with a particular analyte. The present invention provides methods for determining the association of a particular disease or condition with a particular analyte.

“Screening” in the context of diagnosis refer to the process of determining the likelihood that an individual suffers from one or more diseases or conditions. Accordingly, a screen may diagnose a disease or condition, or may alternatively provide an indication that a subject may suffer from one or more diseases or conditions without providing an accompanying diagnosis. “Screening for the necessity for further diagnosis” and like terms refer to a screening process, the results of which indicate that additional diagnostic procedure (i.e., further diagnosis) is necessary to provide identification (i.e., diagnosis) of one or more diseases or conditions.

Diseases or conditions contemplated by the present invention include diseases or conditions for which newborn infants are routinely screened, including without limitation, biotimidase deficiency, congenital adrenal hyperplasia, congenital hypothryoidism, galactosemia, hemocystinuria, maple syrup urine disease, medium chain acyl-CoA dehydrogenase deficiency, phenylketonuria, sickle cell disease, tyrosinemia of type 1, cystic fibrosis, hemoglobin C trait, hemoglobin E trait, carnitine uptake defect, long-chain hydroxyacyl-CoA dehydrogenase deficiency, trifunctional protein deficiency, very-long-chain acyl-CoA dehydrogenase deficiency, 3-methylcrontonyl-CoA carboxylase deficiency, beta-ketothiolase deficiency, glutaric acidemia type I, hydroxymethylglutaric aciduria, isovaleric acidemia, form Cbl A methylmalonic acidemia, form Cbl B methylmalonic acidemia, mutase deficiency form methylmalonic acidemia, multiple carboxylase deficiency, propionic acidemia, argininosuccinic acidemia, and citrullinemia.

“Analyte,” “biomarker” and like terms refer to chemical compounds in a fluid sample from a human subject, the concentration of which can be assayed by methods described herein. Examples of analytes include, without limitation, nucleic acids, proteins, peptides, hormones including peptide hormones and steroid hormones.

“Fluid samples” “biofluid” and like terms refer to a sample of body fluid removed from a subject by methods well known in the art. A fluid sample may be used as obtained from a subject, or it may be diluted and/or otherwise manipulated prior to use in the methods of the present invention. Examples of manipulation of fluid samples include, without limitation, treatment with anticoagulent and separation of components of the fluid sample (e.g., production of serum from whole blood, enrichment for proteins, enrichment for nucleic acids, and the like) and retention of a specific component. The term “blood” includes any blood fraction, for example serum, that can be analyzed according to the methods described herein. Serum is a standard blood fraction that can be tested, and is tested in the Examples below. By measuring blood levels of a particular analytes, it is meant that any appropriate blood fraction can be tested to determine blood levels and that data can be reported as a value present in that fraction. “Control fluid sample” refers to a fluid sample from a subject with known diagnosis, either having or not having a specific disease or condition. In some embodiments, the fluid sample is selected from the group consisting of blood spots, whole blood, plasma, serum, and urine.

“Sensitivity” in the context of screening refers to a ratio of numbers representing the results of a specified diagnostic procedure for a specific disease or condition, which procedure is conducted with subjects having a specified disease or condition, and which ratio is defined as true positive results divided by the sum of true positive and false negative results (Eqn. I):

$$sensitivity = \frac{true positive}{( true positive + false negative )} \qquad ( I )$$

wherein “true positive” refers to the number of subjects, each having the specified disease or condition, which are correctly identified as having the specified disease or condition, and “false negative” refers to the number of subjects, each having a specified disease or condition, which are incorrectly identified as not having the specified disease or condition. Examples without limitation of the specified disease or condition, and of the specified diagnostic procedure, are as known in the art or described herein.

“Specificity” in the context of screening refers to a ratio of numbers representing the results of a specified diagnostic procedure for a specific disease or condition, which procedure is conducted with subjects not having a specified disease or condition, which ratio is defined as true negative results divided by the sum of true negative and false positive results (Eqn. II):

$$specificity = \frac{true negative}{( true negative + false positive )} \qquad ( II )$$

wherein “true negative” refers to the number of subjects, each not having the specified disease or condition, which are correctly identified as not having the specified disease or condition, and “false positive” refers to the number of subjects, each not having a specified disease or condition, which are incorrectly identified as having the specified disease or condition. Examples without limitation of the specified disease or condition, and of the specified diagnostic procedure, are as known in the art or described herein.

“Composite assay” refers to an assay procedure which analyzes one or more analytes (i.e., panel of analytes), wherein the concentration of each analyte is independently compared with an independently selected screening criterion. A composite assay can be directed at 1 or more (e.g., 2, 3, 4, 5, 6, 7, 8, 9, 10, 10-15, 15-20, 20-30, or even more) analytes. Preferably, the invention provides composite assays having high sensitivity. “High sensitivity” in the context of diagnosis or screening refers to sensitivity in the range 50% to 60%, 60% to 70%, 70% to 80%, 80% to 90%, 90% to 100%, 80%, 90%, 95%, 99% or even 100%. The present invention provides composite assays having specificity with respect to the disease or condition, which specificity can be, e.g, 0% to 20%, 20% to—30%, 30% to 40$, 40% to 50%, 50% to 60%, 60% to 70%, 70% to 80%, 80% to 90%, 90% to 100%, 80%, 90%, 95%, 99% or even 100%.

By identifying analytes useful in the determination and/or screening of specific diseases or conditions, and by use of statistical methods to identify analytes and groups of analytes which are particularly useful in identifying at-risk subjects (i.e., subject potentially having the disease or condition), panels of analytes with associated screening criteria can be composed having specified selectivity and sensitivity.

“Criteria,” “threshold values,” “threshold differences” and like terms refers to numeric values to which analyte concentrations are compared. “Screening criteria” and like terms refer to criteria for diagnosis or screening, which criteria are determined by methods of the present invention or by methods known in the art. “Independently selected screening criteria” refers to one or more screening criteria for one or more diseases or conditions, each criteria for each disease or condition being independently selected. “Associated screening criteria” and like terms refer to criteria as defined herein germane to the diagnosis or screening of a particular disease in view of assay of a particular analyte. Generally speaking, one or more analytes may be either depressed or elevated in the disease state. Accordingly, criteria include a designation (i.e., greater than, less than) which provides the relationship of the analyte concentration to the numerical value of a criterion in a specified disease state. In certain instances, analyte concentration may deviate in the disease state from a range of values found in the non-disease state. Accordingly, separate criteria can be provided with respect to the upper and lower bounds of the non-disease range.

The present invention additionally provides methods for the identification of analytes to be used for the screening methods of the invention. The present invention further provides various methods for assessing the relative importance (i.e., weight) of specific analytes in screening methods of the invention. Exemplary methods for assessing the relative importance of analytes include, without limitation, projection of compiled results on a proximity map, whereby the proximity of a subject's determined analytes concentrations to a cluster of other subjects' determined concentrations, which other subjects were previously diagnosed as having a specified disease or condition, contributes to a positive indication of likelihood of a disease or condition. Other methods for assessing the relative importance of analytes in methods of the present invention include the application of one or more statistical methods (e.g., linear regression analysis, classification tree analysis, heuristic nave Bayes analysis and the like). The methods for assessing the relative importance of analytes in methods of the present invention may further include comparing the levels of one or more (e.g., 1, 2, 3, 4, 5, 6, 7, 8, 9, 10, 10-15, 15-20, 20-30, or even more) analytes from a fluid sample from a subject with levels of the same analytes in one or more control fluid samples by applying a statistical method such as: linear regression analysis, classification tree analysis and heuristic nave Bayes analysis. The statistical methods of the present invention may be, and typically are, performed by a computer process, such as by commercially available statistical analysis software. In one embodiment, the statistical method is a classification tree analysis, for example CART (Classification and Regression Tree). Results for a particular patient or subject, whose sample fluid is tested against a panel of analytes according to the method, can be projected onto a proximity map. The statistical methods of the present invention may additionally include analysis of variance (ANOVA), which as well known in the art is a collection of statistical models and associated procedures which compare means by splitting the overall observed variance into different parts.

Statistical methods can be used to define the critical range of concentration values of the variety of analytes contemplated by the present invention. Typically within one standard deviation of those approximate values might be considered as statistically significant values for determining a statistically significant difference, preferably two standard deviations. “Statistical classification methods” are used to identify analytes capable of discriminating normal (i.e., without disease or condition) subjects from subjects with galactosemia and are further used to determine critical blood values for each analyte for discriminating between such subjects. Certain statistical methods can be used to identify discriminating analytes and panels thereof. These statistical methods may include, but are not limited to: 1) linear regression; 2) classification tree methods; and 3) statistical machine learning to optimize the unbiased performance of algorithms for making predictions. Each of these statistical methods is well-known to those of ordinary skill in the field of biostatistics and can be performed as a process in a computer. A large number of software products are available commercially to implement statistical methods, such as, without limitation, S-PLUS™, commercially available from Insightful Corporation of Seattle, Wash.

“Determining” and surrogate terms in the context of screening methods of the present invention refer to the drawing of a conclusion whether further diagnosis is needed, such conclusion based on one or more comparisons conducted between one or more analyte concentrations and associated screening criteria, each analyte having an associated criterion. Generally speaking, for a single analyte system, if the concentration of a single analyte exceeds a threshold difference with respect to an associated criterion, the decision is drawn that further diagnosis is needed. For systems contemplating a plurality of analytes, the decision may be based on one analyte, or any subset of the analytes forming the plurality.

In another aspect, the invention provide a method for selecting independent screening criteria for a composite assay, which method includes the steps of: (a) providing a first plurality of analyte concentrations obtained from fluid samples from a first group (i.e., control group) of subjects, which first group of subjects have no diagnosis for a first disease; (b) providing a second plurality of analyte concentrations obtained from fluid samples from a second group (i.e., diseased group) of subjects, which second group of subjects have a diagnosis for the first disease; (c) performing a principal component analysis of the first and second pluralities of analyte concentrations, thereby providing an ordered list of principal components; and (d) selecting one or more analytes and associated criteria for a composite assay based on relative weights of the analytes in the ordered list of principal components, thereby providing independent screening criteria for a composite assay.

In another aspect, the invention provides method for selecting one or more analytes and associated screening criteria suitable for a composite assay useful for the determination of the necessity for further diagnosis of a plurality of diseases or conditions in a human subject, which method includes the following steps: (a) providing a first set of analytes and associated screening criteria adapted to evaluate the likelihood that a human subject is suffering from a first disease or condition; (b) providing a second set of analytes and associated screening criteria adapted to evaluate the likelihood that the human subject is suffering from a second disease or condition; and (c) selecting common analytes and associated screening criteria from said sets of analytes and associated screening criteria, thereby providing one or more analytes and associated screening criteria suitable for a composite assay.

Other aspects of the invention will become apparent to those of ordinary skill in the art after consideration of the detailed description and claims provided herewith.

### DETAILED DESCRIPTION OF THE PREFERRED EMBODIMENTS

The present invention provides methods for screening subjects for those that may need further diagnosis of one or more diseases or conditions. In certain embodiments, the subject is a human subject. In certain embodiments, the human subject is a neonate.

In some embodiments, the independently selected screening criteria of the present invention are adapted such that the composite assay of the invention achieves a sensitivity of 50% to 60%, 60% to 70%, 70% to 80%, 80% to 90%, 90% to 100%, 80%, 90%, 95%, 99% or even 100%. In some embodiments, the sensitivity is at least 90%. In some embodiments, the sensitivity is at least 95%. In some embodiments, the sensitivity is at least 99%. In some embodiments, the sensitivity is 100%.

Without being held to or bound by the methodology or theory and as will be described in detail below, the present inventors have identified several analytes that are common to specific, sometimes disparate, diseases. The present inventors have thus hypothesized that certain (and other) of the identified analytes may be useful in diagnosing the presence or absence of disease. In other words, the present inventors have determined that abnormal levels of certain analytes are present in unhealthy subjects and normal levels of certain analytes are present in healthy subjects. To be sure, these identified analytes are typically not sufficient to identify the abnormal condition in an unhealthy subject, only that the subject is suffering from a disease condition.

Identification of analytes, and establishment of the significance of selected criteria therefor, for screening of specific diseases or conditions by methods of the present invention are determined statistically by comparing control fluid sample (preferably, e.g., serum or plasma) levels of selected analytes with fluid sample levels in subjects with a known diagnosis of the specific disease or condition. Some embodiments contemplate a single analyte. Some embodiments contemplate a plurality (i.e., panel) of analytes (e.g., 1, 2, 3, 4, 5, 6, 7, 8, 9, 10, 10-15, 15-20, 20-30, or even more analytes). In some embodiments, the composite assay of the invention contemplates a single analyte. In some embodiments, the composite assay of the invention contemplates a plurality of analytes. In some embodiments contemplating a plurality of analytes, the results of the composite assay are based on a deviation of each and every contemplated analyte from control values, as described herein. In some embodiments, the results of the composite assay are based on a deviation of a subset of the plurality of analytes so contemplated. For example without limitation, if the plurality of analytes numbered 10, deviation in the concentration of any 1, 2, 3, 4, 5, 6, 7, 8 or 9 such analytes in view of the criteria established for each analyte would establish a necessity for further diagnosis according to the present invention.

The analytes used in the method of the invention can be detected, for example, by a binding assay. The term “binding reagent” and like terms, refers to any compound, composition or molecule capable of specifically or substantially specifically (that is with limited cross-reactivity) binding another compound or molecule, which, in the case of immune-recognition is an epitope. The binding reagents typically are antibodies, preferably monoclonal antibodies, or derivatives or analogs thereof, but also include, without limitation: Fᵥ fragments; single chain Fᵥ (scFᵥ) fragments; Fab' fragments; F(ab')₂ fragments; humanized antibodies and antibody fragments; camelized antibodies and antibody fragments; and multivalent versions of the foregoing. Multivalent binding reagents also may be used, as appropriate, including without limitation: mono-specific or bi-specific antibodies, such as disulfide stabilized Fᵥ fragments, scFᵥ tandems ((scFᵥ)₂ fragments), dibodies, tribodies or tetrabodies, which typically are covalently linked or otherwise stabilized (i.e., leucine zipper or helix stabilized) scFᵥ fragments. “Binding reagents” also include aptamers, as are described in the art.

Methods of making antigen-specific binding reagents, including antibodies and their derivatives and analogs and aptamers, are well-known in the art. Polyclonal antibodies can be generated by immunization of an animal. Monoclonal antibodies can be prepared according to standard (hybridoma) methodology. Antibody derivatives and analogs, including humanized antibodies can be prepared recombinantly by isolating a DNA fragment from DNA encoding a monoclonal antibody and subcloning the appropriate V regions into an appropriate expression vector according to standard methods. Phage display and aptamer technology is described in the literature and permit in vitro clonal amplification of antigen-specific binding reagents with very affinity low cross-reactivity. Phage display reagents and systems are available commercially, and include the Recombinant Phage Antibody System (RPAS), commercially available from Amersham Pharmacia Biotech, Inc. of Piscataway, N.J. and the pSKAN Phagemid Display System, commercially available from MoBiTec, LLC of Marco Island, Fla. Aptamer technology is described for example and without limitation in U.S. Pat. Nos. 5,270,163, 5,475,096, 5,840,867 and 6,544,776.

In some embodiments, determining the concentration of one or more analytes in a fluid sample contemplates the use of one or more immunoassays. Representative immunoassay include the ELISA and Luminex LabMAP immunoassays described below, which assays are examples of sandwich assays. The term “sandwich assay” refers to an immunoassay where the antigen is sandwiched between two binding reagents, which are typically antibodies. The first binding reagent/antibody being attached to a surface and the second binding reagent/antibody comprising a detectable group. Examples of detectable groups include, for example and without limitation: fluorochromes, enzymes, epitopes for binding a second binding reagent (for example, when the second binding reagent/antibody is a mouse antibody, which is detected by a fluorescently-labeled anti-mouse antibody), for example an antigen or a member of a binding pair, such as biotin. The surface may be a planar surface, such as in the case of a typical grid-type array (for example, but without limitation, 96-well plates and planar microarrays), as described herein, or a non-planar surface, as with coated bead array technologies, where each “species” of bead is labeled with, for example, a fluorochrome (such as the Luminex technology described herein and in U.S. Pat. Nos. 6,599,331, 6,592,822 and 6,268,222), or quantum dot technology (for example, as described in U.S. Pat. No. 6,306,610).

In the bead-type immunoassays described in the examples below, the Luminex LabMAP system is utilized. The LabMAP system incorporates polystyrene microspheres that are dyed internally with two spectrally distinct fluorochromes. Using precise ratios of these fluorochromes, an array is created consisting of 100 different microsphere sets with specific spectral addresses. Each microsphere set can possess a different reactant on its surface. Because microsphere sets can be distinguished by their spectral addresses, they can be combined, allowing up to 100 different analytes to be measured simultaneously in a single reaction vessel. A third fluorochrome coupled to a reporter molecule quantifies the biomolecular interaction that has occurred at the microsphere surface. Microspheres are interrogated individually in a rapidly flowing fluid stream as they pass by two separate lasers in the Luminex analyzer. High-speed digital signal processing classifies the microsphere based on its spectral address and quantifies the reaction on the surface in a few seconds per sample.

For the assays described herein, the bead-type immunoassays are preferable for a number of reasons. As compared to ELISAs, costs and throughput are far superior. As compared to typical planar antibody microarray technology (for example, in the nature of the BD Clontech Antibody arrays, commercially available form BD Biosciences Clontech of Palo Alto, Calif.), the beads are far superior for quantification purposes because the bead technology does not require pre-processing or titering of the plasma or serum sample, with its inherent difficulties in reproducibility, cost and technician time. For this reason, although other immunoassays, such as, without limitation, ELISA, RIA and antibody microarray technologies, are capable of use in the context of the present invention, but they are not preferred. As used herein, “immunoassays” refer to immune assays, typically, but not exclusively sandwich assays, capable of detecting and quantifying a desired blood biomarker, namely at least one of Eotaxin, MCP-1, Alpha-2 Macroglobulin, Apolipoprotein H, Cancer Antigen 125, Leptin, TNF RII, Alpha-Fetoprotein, IgM, MIP-1-alpha, Ferritin, and IgE or any combination of the foregoing.

In some embodiments of the present invention, the independently selected screening criteria of the present invention are adapted such that the composite assay of the invention achieves a specificity of 0% to 20%, 20% to—30%, 30% to 40$, 40% to 50%, 50% to 60%, 60% to 70%, 70% to 80%, 80% to 90%, 90% to 100%, 80%, 90%, 95%, 99% or even 100%. In some embodiments, the specificity is at least 90%. In some embodiments, the specificity is at least 95%. In some embodiments, the specificity is at least 99%. In some embodiments, the specificity is 100%.

Diseases or conditions present that may yield an “abnormal” or “unhealthy” result include biotimidase deficiency, congenital adrenal hyperplasia, congenital hypothryoidism, galactosemia, hemocystinuria, maple syrup urine disease, medium chain acyl-CoA dehydrogenase deficiency, phenylketonuria, sickle cell disease, tyrosinemia of type 1, cystic fibrosis, hemoglobin C trait, hemoglobin E trait, carnitine uptake defect, long-chain hydroxyacyl-CoA dehydrogenase deficiency, trifunctional protein deficiency, very-long-chain acyl-CoA dehydrogenase deficiency, 3-methylcrontonyl-CoA carboxylase deficiency, beta-ketothiolase deficiency, glutaric acidemia type I, hydroxymethylglutaric aciduria, isovaleric acidemia, form Cbl A methylmalonic acidemia, form Cbl B methylmalonic acidemia, mutase deficiency form methylmalonic acidemia, multiple carboxylase deficiency, propionic acidemia, argininosuccinic acidemia, and citrullinemia.

In some embodiments, the analytes contemplated by the present invention are selected from the group consisting of nucleic acids, proteins, polypeptides, peptide hormones and steroid hormones. In some embodiments, analytes contemplated by the invention include proteins. In some embodiments, analytes contemplated by the invention are immunoglobulins as understood by one of skill in the art. In some embodiments, the analytes contemplated by the invention are growth factors, chemokines or cytokines as understood by one of skill in the art (e.g., granulocyte-colony stimulating factor (G-CSF), granulocyte-macrophage colony stimulating factor (GM-CSF), nerve growth factor (NGF), neurotrophins, platelet-derived growth factor (PDGF), erythropoietin (EPO), thrombopoietin (TPO), myostatin (GDF-8), growth differentiation factor-9 (GDF9), basic fibroblast growth factor (bFGF or FGF2), epidermal growth factor (EGF), hepatocyte growth factor (HGF), eotaxin and the like). In some embodiments, analytes contemplated by the invention include peptide hormones (e.g., corticotropin-releasing hormone (CRH), gonadotropin-releasing hormone (GnRH), growth hormone releasing hormone (GHRH), somatostatin, thyrotropin-releasing hormone (TRH), hypocretin, antidiuretic hormone (ADH) and the like).

In some embodiments of the method of selecting independent screening criteria for a composite assay, the sensitivity of the composite assay is at least 80%. In some embodiments, the sensitivity is at least 90%, at least 95% or even 100%. In some embodiments, the number of analytes selected is 1. In further embodiments, the number of analytes selected is 2-10, 11-20, 21-30 or even greater than 30.

In some embodiments of the method for selecting one or more analytes and associated screening criteria suitable for a composite assay useful for the determination of the necessity for further diagnosis of a plurality of diseases or conditions in a human subject, steps (b) and (c) are repeated with an additional set of analytes and associated screening criteria. Accordingly, in some embodiments, the composite assay of the invention contemplates a plurality of diseases or conditions (e.g., 2, 3, 4, 5, 6, 7, 8, 9, 10, 22-15, 16-20, 20-30, or even more than 30) for screening for the necessity for further diagnosis by the methods of the present invention.

### Example 1

### Subject Populations

Subject populations for the development of independently selected screening criteria for a specific disease or condition according to the present invention can be chosen based on a confirmed diagnosis (i.e., either having or lacking the disease or condition) made by a clinician trained and experienced in diagnosing the disease or condition. Consent and blood specimens from all subjects can be obtained under informed consent.

### Example 2

### Specimen Collection

Blood specimens. Dried blood spot specimens can be clinical specimens collected by applying a few drops of blood, freshly drawn by finger stick with a lancet from adults, or by heel stick with a lancet from infants, onto specially manufactured absorbent specimen collection material (e.g., filter paper). The blood can be allowed to saturate the collection material and then air dried for a minimum of 3 hours. Caked or clotted specimens are not desirable and therefore should not be employed in the methods of the present invention. The specimen collection technique and the specifications for specimen matrix and shipment can be those published as a national standard by the National Committee for Clinical Laboratory Standards. Specimen collection materials (“collection kits”) for newborn screening may include a sturdy paper overlay that covers the absorbent filter paper containing the dried specimen. These can be enclosed and sealed in a high quality bond envelope. The paper overlay and the sealed bond envelope can provide a double-layer barrier that protects casual handlers (i.e., shipping handlers and other nonlaboratory, non-technical personnel) from accidental exposure to the dried blood specimens and protects the specimens from exposure to the environment during shipping. Additionally, blood samples can be samples of peripheral blood drawn from subjects using standardized phlebotomy procedures. Blood samples can be collected with/without anticoagulant into suitable containers (e.g., red top vacutainers, and the like). Sera can be separated by standard methods, including without limitation, centrifugation. All specimens should be immediately frozen after collection and stored in the dedicated −80 C freezer. All blood samples should be logged on the study computer to track information such as storage date, freeze/thaw cycles and distribution.

### Example 3

### Development of Luminex Assay

The reagents for multiplex system were developed using antibody pairs purchased from R&D Systems (Minneapolis, Minn.), Fitzgerald Industries International (Concord, Mass.) or produced by well known immunological methods. Capture antibodies were monoclonal and detection antibodies were polyclonal. Capture antibodies were covalently coupled to carboxylated polystyrene microspheres number 74 (Luminex Corporation, Austin, Tex.). Covalent coupling of capture antibodies to microspheres was performed by following the procedures recommended by Luminex. Briefly, microsphere stock solutions were dispersed in a sonification bath (Sonicor Instrument Corporation, Copiague, N.Y.) for 2 min. An aliquot of about 2.5×10⁶ microspheres was resuspended in microtiter tubes containing 0.1 M sodium phosphate buffer, pH 6.1 (phosphate buffer), to a final volume of 80 μL.

The resulting suspension was sonicated until a homogeneous distribution of the microspheres was observed. Solutions of N-hydroxy-sulfosuccinimide (Sulfo-NHS) and 1-ethyl-3-(3-dimethylaminopropyl)-carbodiimide hydrochloride (Pierce), both at 50 mg/mL, were prepared in phosphate buffer, and 10 μL of each solution was sequentially added to stabilize the reaction and activate the microspheres. The suspension was incubated for 10 min at room temperature and then resuspended in 250 μL of PBS containing 50 μg of antibody. The mixture was incubated overnight in the dark with continuous shaking Microspheres were then incubated with 250 μL of PBS-0.05% Tween 20 for 4 h. After aspiration, the beads were blocked with 1 mL of PBS-1% BSA-0.1% sodium azide. The microspheres were counted with a hemacytometer and stored at a final concentration of 10⁶ microspheres per mL in the dark at 4 C.

Coupling efficiency of monoclonal antibodies was tested by staining 2,000 microspheres with PE-conjugated goat anti-mouse IgG (BD Biosciences, San Diego, Calif.). Detection antibodies were biotinylated using EZ-Link Sulfo-NHS-Biotinylation Kit (Pierce, Rockford, Ill.) according to manufacturer's protocol. The extent of biotin incorporation was determined using HABA assay using methods well-known in the art and was 20 moles of biotin per mole of protein. The assays were further optimized for concentration of detection antibody and for incubation times.

Sensitivity of the antibody assays were determined using serially diluted purified proteins. “Sensitivity” in the context of antibody assay refers to affinity of the antibodies of the assay for target protein, e.g., analyte of the invention. Intra-assay variability, expressed as a coefficient of variation, was calculated based on the average for patient samples and measured twice at two different time points. The intra-assay variability within the replicates is expressed as an average coefficient of variation. Inter-assay variability was evaluated by testing quadruplicates of each standard and sample with an average of 16.5% (data not shown). Newly developed kits were multiplexed together and the absence of cross-reactivity was confirmed according to Luminex protocol.

Examples of commercial sources of matched antibody cytokine pairs include MAB636 EGF (R&D Systems, Minneapolis, Minn.), BAF236 G-CSF (R&D Systems), DY214 IL-6 (R&D Systems), DY206 IL-8 (R&D Systems), DY208 IL-12p40 (R&D Systems), DY1240 MCP-1 (R&D Systems), DY279 VEGF (R&D Systems), DY293 CA-125 (M002201, M002203, Fitzgerald Industries International, Inc., Concord, Mass.).

### Example 4

### Development of LabMAP Assay for Circulating Antibodies

Assays were performed in filter-bottom 96-well microplates (Millipore). Purified antigens of interest were coupled to Luminex beads as described for antibodies. Antigen-coupled beads were pre-incubated with blocking buffer containing 4% BSA for 1 h at room temperature on microtiter shaker. Beads were then washed three times with washing buffer (PBS, 1% BSA, 0.05% Tween 20) using a vacuum manifold followed by incubation with 50 μL blood serum diluted 1:250 for 30 min at 4 C.

Next, washing procedure was repeated as above and beads were incubated with 50 μL/well of 4 μg/mL PE-conjugated antibody raised against human IgG (Jackson Laboratories), for 45 min in the dark with the constant shaking Wells were washed twice, assay buffer was added to each well and samples were analyzed using the Bio-Plex suspension array system (Bio-Rad Laboratories, Hercules, Calif.). For standard curve, antigen-coupled beads were incubated with serially diluted human antibodies against specific antigens. Purification of monospecific human antibodies is described above. Data analysis was performed using five-parametric-curve fitting.

### Example 5

### Galactosemia

Table 1 provides mean values and accompanying standard deviations for fluid sample (i.e., blood) levels of analytes in galactosemic subjects and in control subjects (i.e., no galactosemia) that can be diagnostic. Materials and methods in identifying the analytes and evaluating same are described hereinabove and in U.S. provisional application No. 60/884,827 filed, Jan. 12, 2007, the entire disclosure of which is incorporated herein by reference. If any one or more, two or more, typically three or four or more of the following conditions are met in a patient's blood—eotaxin (less than about 370 pg/mL), MCP-1 (less than about 2 ng/mL), alpha-2 macroglobulin (greater than about 2.0 mg/mL), apolipoprotein H (less than about 55 ug/mL), CA 125 (greater than about 5.0 U/mL), leptin (greater than about 0.57 ng/mL), TNF RII (less than about 5.95 ng/mL), alpha-fetoprotein (less than about 330 ng/mL), IgM (greater than about 0.051 mg/mL), MIP-1 alpha (less than about 38 pg/mL), ferritin (less than about 2930 ng/mL), and IgE (greater than about 300 ng/mL)—there is a very high likelihood that the patient has suffered or is suffering from galactosemia. It should be understood that these values are approximate.

TABLE 1
Significant analytes related to galactosemia

| | | Galactosemia | Control | P value |
|---|---|---|---|---|
| | Units | (Mean) | (Mean) | (t-test) |
| Eotaxin | pg/mL | 225 | 469 | 7.6E−06 |
| MCP-1 | ng/mL | 1.3 | 3.2 | 2.8E−04 |
| Alpha-2 Macrogobulin | mg/mL | 2.7 | 1.8 | 1.8E−03 |
| Apolipoprotein H | ug/mL | 47 | 67 | 6.3E−03 |
| CA 125 | U/mL | 7.8 | 4.2 | 1.1E−02 |
| Leptin | ng/mL | 1.2 | 0.46 | 1.2E−02 |
| TNF RII | ng/mL | 5.8 | 8.1 | 2.0E−02 |
| Alpha-Fetoprotein | ng/mL | 493 | 206 | 3.1E−02 |
| IgM | mg/mL | 0.21 | 0.055 | 3.5E−02 |
| MIP-1-alpha | ug/mL | 30 | 44 | 3.6E−02 |
| Ferritin | ng/mL | 2590 | 5201 | 4.3-02 |

Referring now to Table 2, screening results for the analytes recited in Table 1 are tabulated with respect to true (i.e., diagnosed) disease state for galactosemia, result of screen, specificity, sensitivity, and accuracy. “Disease State Negative” refers to correct no disease in subject. “Disease State Positive” refers to subjects having the disease. “Result Neg” refers to a negative result of the assay (i.e., assay indicating no disease). “Result Pos” refers to a positive result of the assay (i.e., assay indicating disease present). Specificity and sensitivity were calculated as described herein. “Accuracy” is calculated as the ratio of total subjects correctly screened to total subjects assayed.

TABLE 2
Sensitivity, specificity, and accuracy in galactosemia screen.

| | Disease | Result | | | | |
|---|---|---|---|---|---|---|
| Analyte | State | Neg | Pos | Specificity | Sensitivity | Accuracy |
| Eotaxin | Negative | 10 | 0 | 100% | | |
| | Positive | 0 | 10 | | 100% | 100% |
| MCP-1 | Negative | 9 | 1 | 90% | | |
| | Positive | 1 | 9 | | 90% | 90% |
| Alpha-2 | Negative | 8 | 2 | 80% | | |
| Macro- | Positive | 0 | 10 | | 100% | 90% |
| globulin | | | | | | |
| Apolipo- | Negative | 10 | 0 | 100% | | |
| protein-H | Positive | 3 | 7 | | 70% | 85% |
| CA-125 | Negative | 9 | 1 | 90% | | |
| | Positive | 2 | 8 | | 80% | 85% |
| Leptin | Negative | 7 | 3 | 70% | | |
| | Positive | 1 | 9 | | 90% | 80% |
| TNF-RII | Negative | 9 | 1 | 90% | | |
| | Positive | 4 | 6 | | 60% | 75% |
| Alpha- | Negative | 9 | 1 | 90% | | |
| Feto- | Positive | 3 | 7 | | 70% | 80% |
| protein | | | | | | |
| IgM | Negative | 10 | 0 | 100% | | |
| | Positive | 4 | 6 | | 60\hat{ } | 80% |
| MIP-1 | Negative | 7 | 3 | 70% | | |
| alpha | Positive | 4 | 6 | | 60% | 65% |
| Ferritin | Negative | 9 | 1 | 90% | | |
| | Positive | 3 | 7 | | 70% | 80% |
| IgE | True Neg | 7 | 3 | 70% | | |
| | Positive | 2 | 8 | | 80% | 75% |

### Example 6

### Sickle Cell Disease (SCD) Assay

Statistical data presented below in Table 3 identify mean values and accompanying standard deviations for the blood levels of the above-described biomarkers in subjects having SCD and in subjects without SCD. Materials and methods in identifying the analytes and evaluating same are described hereinabove and in U.S. provisional application No. 60/890,305 filed, Feb. 16, 2007, the entire disclosure of which is incorporated herein by reference. “Carrier” refers to a subject heterozygous for SCD. It should be understood that these values are approximate.

TABLE 3
Significant Analytes in SCD Study

| | | | | Control | | Control |
|---|---|---|---|---|---|---|
| | | | | v SS t- | | v Carrier |
| | Units | Control | Sickle Cell | test | Carrier | t-test |
| Eotaxin | pg/mL | 393 | 165 | 7.70E−06 | 163 | 2.40E−05 |
| IL-12p40 | ng/mL | 0.92 | 0.5 | 2.20E−03 | 0.9 | 7.30E−01 |
| SHBG | nmol/L | 28 | 19 | 8.70E−03 | 23 | 3.10E−01 |
| MMP-9 | ng/mL | 125 | 254 | 9.10E−03 | 97 | 1.40E−01 |
| Adiponectin | ug/mL | 12 | 8.7 | 1.20E−02 | 11 | 6.80E−01 |
| Haptoglobin | mg/mL | 0.027 | 0.02 | 1.40E−02 | 0.023 | 8.40E−02 |
| FGF basic | pg/mL | 265 | 124 | 1.80E−02 | 116 | 8.40E−03 |
| MCP-1 | pg/mL | 2401 | 1369 | 1.90E−02 | 764 | 7.80E−07 |
| IgM | mg/mL | 0.062 | 0.037 | 2.20E−02 | 0.059 | 8.00E−01 |
| Growth Hormone | ng/mL | 18 | 31 | 2.60E−02 | 22 | 4.40E−01 |
| Factor VII | ng/mL | 169 | 114 | 3.60E−02 | 150 | 5.50E−01 |

The results described in Table 3 demonstrate that serum eotaxin levels are depressed in SCD subjects. Thus, eotaxin can be used as an early biomarker of sickle cell conditions. Similarly, monocyte chemotactic protein-1 (MCP-1) levels are depressed in sickle cell conditions. Thus, MCP-1 can be used as an early biomarker of sickle cell conditions.

Table 4 illustrates the diagnostic accuracy obtained by testing for each individual analyte and determining how useful it would be as a diagnostic tool with respect to SCD. The terms in Table 4 are as defined for Table 2 above.

TABLE 4
Analyte Specificity, Sensitivity and Accuracy for SCD

| | Disease | Result | | | | |
|---|---|---|---|---|---|---|
| Analyte | State | Neg | Pos | Specificity | Sensitivity | Accuracy |
| Eotaxin | Negative | 10 | 0 | 100% | | |
| | Positive | 0 | 10 | | 100% | 100% |
| MCP-1 | Negative | 8 | 2 | 80% | | |
| | Positive | 2 | 8 | | 80% | 80% |
| IL-12p40 | Negative | 10 | 0 | 100% | | |
| | Positive | 2 | 8 | | 80% | 90% |
| SHBG | Negative | 8 | 2 | 80% | | |
| | Positive | 2 | 8 | | 80% | 80% |
| Factor VII | Negative | 8 | 2 | 80% | | |
| | Positive | 2 | 8 | | 80% | 80% |
| MMP-9 | Negative | 8 | 2 | 80% | | |
| | Positive | 2 | 8 | | 80% | 80% |
| Adipo- | Negative | 7 | 3 | 70% | | |
| nectin | Positive | 3 | 7 | | 70% | 70% |
| Hapto- | Negative | 9 | 1 | 90% | | |
| globin | Positive | 2 | 8 | | 80% | 85% |
| FGF-basic | Negative | 7 | 3 | 70% | | |
| | Positive | 1 | 9 | | 90% | 80% |
| IgM | Negative | 6 | 4 | 60% | | |
| | Positive | 1 | 9 | | 90% | 75% |
| Growth | Negative | 7 | 3 | 70% | | |
| Factor | Positive | 0 | 10 | | 100% | 85% |

### Example 7

### Acute Coronary Syndrome (ACS)

Statistical data presented below in Table 5 identify mean values and accompanying standard deviations for the blood levels of 40 analytes in subjects having acute coronary syndrome (ACS) and in subjects without ACS. Materials and methods in identifying the analytes provided in Table 5 are described hereinabove and in U.S. Provisional Application No. 60/694,666, filed Jun. 29, 2005, U.S. application Ser. No. 11/475,249, filed Jun. 27, 2006, and International Application No. PCT/US2006/025008, filed Jun. 27, 2006, all of which are incorporated herein by reference in their entireties and for all purposes. It should be understood that these values are approximate.

TABLE 5
Significant Analytes in ACS Study

| | | ACS | ACS | Control | Control | P value |
|---|---|---|---|---|---|---|
| Analyte | Units | Mean | SD | Mean | SD | (t-test) |
| IL-18 | pg/mL | 378 | 184 | 128 | 88 | 8.7E−22 |
| Factor VII | ng/mL | 523 | 170 | 205 | 58 | 1.7E−21 |
| SGOT | ug/mL | 5.7 | 9.8 | 21 | 4.4 | 6.3E−21 |
| ICAM-1 | ng/mL | 216 | 92 | 108 | 31 | 2.0E−19 |
| Creatine Kinase-MB | ng/mL | 32 | 25 | 0.69 | 0.70 | 2.0E−19 |
| MCP-1 | pg/mL | 349 | 159 | 151 | 124 | 9.4E−15 |
| Myoglobin | ng/mL | 73 | 71 | 16 | 7.8 | 2.8E−13 |
| MMP-3 | ng/mL | 10 | 8.5 | 0.41 | 0.31 | 4.9E−11 |
| C Reactive Protein | ug/mL | 17 | 19 | 3.4 | 4.1 | 9.5E−11 |
| von Willebrand Factor | ug/mL | 25 | 14 | 12 | 9.4 | 2.2E−10 |
| TIMP-1 | ng/mL | 136 | 50 | 100 | 18 | 1.6E−09 |
| Ferritin | ng/mL | 355 | 292 | 178 | 124 | 1.2E−07 |
| Glutathione S-Transferase | ng/mL | 22 | 25 | 0.62 | 0.55 | 1.5E−07 |
| Prostate Specific Antigen, | ng/mL | 0.47 | 0.35 | 0.20 | 0.24 | 3.5E−07 |
| Free | | | | | | |
| IL-3 | ng/mL | 0.46 | 0.28 | 0.087 | 0.059 | 8.2E−07 |
| Tissue Factor | ng/mL | 5.4 | 3.6 | 2.9 | 2.1 | 2.0E−06 |
| Alpha-Fetoprotein | ng/mL | 7.5 | 3.7 | 4.7 | 2.7 | 3.6E−06 |
| Prostatic Acid Phosphatase | ng/mL | 0.41 | 0.30 | 0.24 | 0.15 | 6.4E−06 |
| Stem Cell Factor | pg/mL | 98 | 54 | 44 | 37 | 3.3E−05 |
| MIP-1beta | pg/mL | 147 | 159 | 79 | 52 | 7.5E−05 |
| Carcinoembryonic Antigen | ng/mL | 3.5 | 4.4 | 1.7 | 1.3 | 1.3E−04 |
| IL-13 | pg/mL | 57 | 35 | 41 | 14 | 1.9E−04 |
| TNF-alpha | pg/mL | 17 | 27 | 7.3 | 5.7 | 6.3E−04 |
| IgE | ng/mL | 260 | 327 | 108 | 161 | 1.4E−03 |
| Fatty Acid Binding Protein | ng/mL | 20 | 26 | 6.6 | 6.7 | 1.5E−03 |
| ENA-78 | ng/mL | 1.2 | 1.3 | 0.64 | 0.70 | 1.9E−03 |
| IL-1beta | pg/mL | 7.0 | 6.9 | 4.0 | 3.1 | 2.2E−03 |
| Brain-Derived Neurotrophic | ng/mL | 3.6 | 4.7 | 2.2 | 1.8 | 3.2E−03 |
| Factor | | | | | | |
| Apolipoprotein A1 | mg/mL | 0.68 | 0.48 | 0.84 | 0.21 | 4.0E−03 |
| Serum Amyloid P | ug/mL | 34 | 7.0 | 30 | 8.7 | 5.0E−03 |
| Growth Hormone | ng/mL | 1.5 | 1.5 | 0.72 | 1.4 | 5.2E−03 |
| Beta-2 Microglobulin | ug/mL | 2.3 | 0.98 | 2.0 | 0.55 | 5.7E−03 |
| Lipoprotein (a) | ug/mL | 99 | 112 | 52 | 84 | 7.5E−03 |
| MMP-9 | ng/mL | 217 | 159 | 313 | 235 | 9.3E−03 |
| Thyroid Stimulating | uIU/mL | 2.1 | 1.4 | 1.5 | 1.1 | 1.0E−02 |
| Hormone | | | | | | |
| Alpha-2 Macroglobulin | mg/mL | 0.39 | 0.65 | 0.23 | 0.078 | 1.0E−02 |
| Complement 3 | mg/mL | 1.4 | 0.65 | 1.2 | 0.26 | 1.2E−02 |
| IL-7 | pg/mL | 37 | 22 | 44 | 16 | 1.9E−02 |
| Leptin | ng/mL | 18 | 30 | 11 | 10 | 2.5E−02 |
| IL-6 | pg/mL | 54 | 43 | 30 | 18 | 3.1E−02 |

Table 6 illustrates the diagnostic specificity, sensitivity, and accuracy obtained by testing analytes selected from Table 5 and determining how useful each would be as a diagnostic tool with respect to ACS. The terms of Table 6 are as defined for Table 2 above.

TABLE 6
Analyte Specificity, Sensitivity and Accuracy for ACS

| | Disease | Result | | | | |
|---|---|---|---|---|---|---|
| Analyte | State | Neg | Pos | Specificity | Sensitivity | Accuracy |
| MMP-3 | Negative | 89 | 0 | 100% | | |
| | Positive | 2 | 57 | | 97% | 99% |
| SGOT | Negative | 88 | 1 | 99% | | |
| | Positive | 3 | 56 | | 95% | 97% |
| CKMB | Negative | 86 | 3 | 97% | | |
| | Positive | 6 | 53 | | 90% | 94% |
| GST | Negative | 85 | 4 | 96% | | |
| | Positive | 8 | 51 | | 86% | 92% |
| Factor VII | Negative | 84 | 5 | 94% | | |
| | Positive | 8 | 51 | | 86% | 91% |
| ICAM-1 | Negative | 82 | 7 | 92% | | |
| | Positive | 9 | 50 | | 84% | 89% |
| MCP-1 | Negative | 84 | 5 | 94% | | |
| | Positive | 13 | 46 | | 78% | 88% |
| IL-18 | Negative | 82 | 7 | 92% | | |
| | Positive | 12 | 47 | | 80% | 87% |
| Myo- | Negative | 80 | 9 | 90% | | |
| globin | Positive | 16 | 43 | | 73% | 83% |
| CRP | Negative | 78 | 11 | 88% | | |
| | Positive | 21 | 38 | | 64% | 78% |
| Ferritin | Negative | 79 | 10 | 89% | | |
| | Positive | 25 | 34 | | 58% | 76% |
| TIMP-1 | Negative | 80 | 9 | 90% | | |
| | Positive | 27 | 32 | | 54% | 76% |

### Example 8

### Proximity Map Data Analysis

A unique chemical signature can be generated using the concentration of the analytes measured in each sample. The relationship of each sample signature is visualized in the Galaxy™ projection. The Galaxy™ is a proximity map, such that the closer two objects are in the visualization, the closer their chemical signatures are, and thus the more similar they are to one another. The axes are dimensionless (a result of being derived from a principal component analysis), and thus the visualization is not a typical X-Y scatter plot in which moving along one axis means increasing or decreasing a single value. The two axes of the Galaxy™ are defined by the first two principal components, a common method to reduce complex data. As well known to those of skill in the art of bioinformatics, Principal Component Analysis (PCA) is a technique for simplifying datasets by reducing multidimensional datasets to lower dimensions for analysis. PCA linearly transforms data to a new coordinate system such that the greatest variance by any projection of the data comes to lie on the first coordinate (called the first principal component), the second greatest variance on the second coordinate, and so on. PCA can be used for dimensionality reduction in a dataset while retaining those characteristics of the dataset that contribute most to its variance, by keeping lower-order (i.e., first, second, etc.) principal components and ignoring higher-order principal components. Such low-order components often contain the “most important” aspects of the data, but this is not necessarily the case and depends on the application as known to one of skill in the art. The placement of objects (record points) is done using a set of heuristics that have been designed to maximize the preservation of spatial relationships that existed in the high-dimensional space of the original data while minimizing the overlap that can occur when doing projections to lower dimensional space.

### Example 9

### Development of Assay for Galactosemia and/or Sickle Cell Disorder

As the data presented Examples 5-7 demonstrate, disease states and/or conditions, though disparate in etiology, can have common elements (i.e., analytes) that are evident in biofluids. Having discovered certain of these analytes, the present inventors have developed assays comprising the common elements for use in “non-specific” (i.e., “non-specific” for a particular disease) assays for diagnosing “health” or “normality”.

These assays comprise (a) obtaining a fluid sample from a human subject; (b) determining the concentration of one or more diagnostic analytes in said fluid sample; and (c) determining if the determined concentration of the one or more diagnostic analytes in said fluid sample is statistically different from that found in a control group of human subjects, whereby a statistically different concentration of the one or more diagnostic analytes supports a positive diagnosis of “abnormality”.

Typically, the human subject is a newborn. With respect to galactosemia, it has been discovered that a measured concentration of about 350 pg/mL or below of eotaxin, about 2.5 ng/mL or below of MCP-1, or both in the fluid sample supports a positive diagnosis of “abnormality.” In a preferred embodiment, the method of the invention further comprises determining the concentration in said fluid sample of at least one of Alpha-2 Macroglobulin, Apolipoprotein H, Cancer Antigen 125, Leptin, TNF RH, Alpha-Fetoprotein, IgM, MIP-1-alpha, Ferritin, IgE, Interleukin-12p40 (IL-12p40), Sex Hormone Binding Globulin (SHBG), Matrix Metalloproteinase-9 (MMP-9), Adiponectin, Haptoglobin, Fibroblast Growth Factor basic (FGF basic), Immunoglobulin M (IgM), Growth Hormone, Factor VII or any combination thereof.

Tables 1 and 3 further identify common analytes therein. To extend the previous example, IgM levels in fluid samples from subjects could also be indicative of a disease condition, and could establish the need for further diagnosis of the identity of the disease. For example, decreased levels of eotaxin in combination with increased levels of IgM would suggest that for the patient may be suffering from galactosemia. Conversely, decreased levels of eotaxin in combination with decreased levels of IgM would suggest that the patient is suffering from SCD.

All patents and other references cited in the specification are indicative of the level of skill of those skilled in the art to which the invention pertains, and are incorporated by reference in their entireties, including any tables and figures, to the same extent as if each reference had been incorporated by reference in its entirety individually.

One skilled in the art would readily appreciate that the present invention is well adapted to obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications may be made to the invention disclosed herein without departing from the scope and spirit of the invention. For example, variations can be made to provide additional independently selected screening criteria of the invention and/or various additional diseases or conditions. Thus, such additional embodiments are within the scope of the present invention and the following claims.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms so as to provide additional embodiments of the invention. The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

The use of numerical values in the various ranges specified in this application, unless expressly indicated otherwise, are stated as approximations as though the minimum and maximum values within the stated ranges were both preceded by the word “about.” In this manner, slight variations above and below the stated ranges can be used to achieve substantially the same results as values within the ranges. Also, the disclosure of these ranges is intended as a continuous range including every value between the minimum and maximum values.

Also, unless indicated to the contrary, where various numerical values are provided for embodiments, additional embodiments are described by taking any two different values as the endpoints of a range. Such ranges are also within the scope of the described invention.

Thus, additional embodiments are within the scope of the invention and within the following claims.

What is claimed is:

1. A method of screening for the necessity for further diagnosis of one or more diseases or conditions in a human subject, said method comprising:
(a) obtaining a fluid sample from a human subject in need of screening for the necessity for further diagnosis of one or more diseases or conditions;
(b) determining the concentration of one or more analytes in said fluid sample;
(c) comparing each said concentration of said one or more analytes with independently selected screening criteria, wherein said independently selected screening criteria are adapted such that the sensitivity of a composite assay is at least 80%; and
(d) determining if said further diagnosis is required, thereby providing said screening for the necessity for further diagnosis of said one or more diseases or conditions in said human subject.

2. The method according to claim 1, wherein said human subject is a newborn.

3. The method according to claim 1, wherein said sensitivity is at least 90%.

4. The method according to claim 1, wherein said sensitivity is at least 95%.

5. The method according to claim 1, wherein said sensitivity is at least 99%.

6. The method according to claim 1, wherein said sensitivity is 100%.

7. The method according to claim 1, wherein said independently selected screening criteria are further adapted such that the specificity of said composite assay is at least 50%.

8. The method according to claim 1, wherein said specificity is at least 90%.

9. The method according to claim 1, wherein said specificity is at least 95%.

10. The method of claim 1, wherein said diseases or conditions are selected from the group consisting of biotimidase deficiency, congenital adrenal hyperplasia, congenital hypothryoidism, galactosemia, hemocystinuria, maple syrup urine disease, medium chain acyl-CoA dehydrogenase deficiency, phenylketonuria, sickle cell disease, tyrosinemia of type 1, fatty acid oxidation disorder, organic acid disorder, urea cycle disorder, cystic fibrosis, hemoglobin C trait and hemoglobin E trait;
wherein said fatty acid oxidation disorder is selected from the group consisting of carnitine uptake defect, long-chain hydroxyacyl-CoA dehydrogenase deficiency, trifunctional protein deficiency, and very-long-chain acyl-CoA dehydrogenase deficiency;
wherein said organic acid disorder is selected from the group consisting of 3-methylcrontonyl-CoA carboxylase deficiency, beta-ketothiolase deficiency, glutaric acidemia type I, hydroxymethylglutaric aciduria, isovaleric acidemia, form Cbl A methylmalonic acidemia, form Cbl B methylmalonic acidemia, mutase deficiency form methylmalonic acidemia, multiple carboxylase deficiency, and propionic acidemia; and
wherein said urea cycle disorder is selected from the group consisting of argininosuccinic acidemia and citrullinemia.

11. The method according to claim 1, wherein said one or more analytes are selected from the group consisting of nucleic acids, proteins, polypeptides, peptide hormones and steroid hormones.

12. The method according to claim 1, wherein said fluid sample is selected from the group consisting of blood spots, whole blood, plasma, serum, and urine.

13. The method according to claim 1, wherein said determining comprises one or more immunoassays for said one or more analytes in said fluid sample.

14. A method for selecting independent screening criteria for a composite assay, said method comprising:
(a) providing a first plurality of analyte concentrations obtained from fluid samples from a first group of subjects, said first group of subjects having no diagnosis for a first disease;
(b) providing a second plurality of analyte concentrations obtained from fluid samples from a second group of subjects, said second group of subjects having a diagnosis for said first disease;
(c) performing a principal component analysis of said first and second pluralities of said analyte concentrations, thereby providing an ordered list of principal components; and
(d) selecting one or more analytes and associated criteria for a composite assay based on relative weights of said analytes in said ordered list of principal components, thereby providing independent screening criteria for a composite assay.

15. The method according to claim 14, wherein the sensitivity of said composite assay is at least 80%.

16. The method according to claim 14, wherein the sensitivity of said composite assay is at least 90%.

17. The method according to claim 14, wherein the sensitivity of said composite assay is at least 95%.

18. The method according to claim 14, wherein the sensitivity of said composite assay is 100%.

19. The method according to claim 14, wherein the number of said selected analytes is 1.

20. The method according to claim 14, wherein the number of said selected analytes is 2-10.

21. The method according to claim 14, wherein the number of said selected analytes is 11-20.

22. The method according to claim 14, wherein the number of said selected analytes is 21-30.

23. The method according to claim 14, wherein the number of said selected analytes is greater than 30.

24. A method for selecting a plurality of analytes and associated screening criteria suitable for a composite assay useful for the determination of the necessity for further diagnosis of a plurality of diseases or conditions in a human subject, said method comprising:
(a) providing a first set of analytes and associated screening criteria adapted to evaluate the likelihood that a human subject is suffering from a first disease or condition;
(b) providing a second set of analytes and associated screening criteria adapted to evaluate the likelihood that said human subject is suffering from a second disease or condition; and
(c) selecting common analytes and associated screening criteria from said sets of analytes and associated screening criteria,
thereby providing said analytes and associated screening criteria for said composite assay.

25. The method of claim 24, wherein steps (b) and (c) are repeated with an additional set of analytes and associated screening criteria adapted to evaluate the likelihood that said human subject is suffering from another disease or condition.
